(19) United States
(12) Patent Application Publication
(10) Pub. No.: US 2018/0194522 A1
(43) Pub. Date: Jul. 12, 2018

(54) CONTAINER WITH CAP OPENING FEATURE

(71) Applicant: Brian Edward Foley, Murrieta, CA (US)

(72) Inventor: Brian Edward Foley, Murrieta, CA (US)

(21) Appl. No.: 15/868,792

(22) Filed: Jan. 11, 2018

Related U.S. Application Data
(60) Provisional application No. 62/445,083, filed on Jan. 11, 2017.

(51) Int. Cl. B65D 41/04

(52) U.S. Cl. CPC B65D 41/0485; B67B 7/14

(57) ABSTRACT

Containers comprise a container body and a cap, wherein the cap comprises a surface feature configured to accommodate engagement with a member to provide desired increased leverage to a user to aid loosening and/or removing the cap from the container. The surface feature may be an opening or any other surface feature, and the member may be another container having a cap or container body having a surface feature configured to complement and fit the surface feature of the cap, forming an interlocking attachment therewith. Both containers may be configured identically, each having surface features that complement one another, thereby forming a system made up of such two containers for loosening/removing the caps of one another. The caps each may include an opening and a section sized to fit in the opening so that the section of one cap fits in the opening of the other cap.

### CROSS-REFERENCE TO RELATED APPLICATIONS

This patent application claims the benefit of U.S. Provisional Patent Application No. 62/445,083, dated Jan. 11, 2017, which is hereby incorporated by reference in its entirety.

### FIELD

Containers as disclosed herein include a lid or cap, wherein the container is configured having one or more features specifically engineered to assist with the loosening and/or removal of such lip or cap of from the container and, more specifically, wherein the container lip or cap includes such one or more features to facilitate the removal of the same from the container by hand.

### BACKGROUND

The use of bottles, cans and other types of products configured to contain a volume of liquid or gas is well known in the art, and are generally referred hereto as “containers”. Such containers generally include an opening for accessing the liquid or gas disposed within the container, which opening may be sealed until desired use/removal through the use of a cap, lid or other element that is generally configured to cover the opening to prohibit an undesired removal of the container contents, e.g., during shipping or storage or otherwise before use of the contents of the container is desired.

Such caps or lids may be configured having a portion that registers with a portion of the respective container positioned at or adjacent the opening. A few examples of well-known containers include those having a cap or lid that is configured to provide a releasable attachment with the container through the use of complementary threaded interaction, or to provide a releasable attachment through an interference squeeze fit, whereby the cap or lid is removed by the respective turning and threaded disengagement of the cap and container, or the urging of the cap or lid over an expanded end of the container opening.

With respect to containers that are configured having a threaded cap or lid attachment, it is well known that the removal of such cap or lid from the container by hand may be difficult, e.g., in instances where the cap is overtightened to the lid, and/or where the cap is sized in a manner making grasping of the cap in one's hand difficult for the purpose of twisting the same for loosening and removal, and/or when a liquid in the container is disposed along a portion of the threaded interaction and possibly dried. In each of these example instances, removal of a cap or lid that is threadably connected or engaged with the container may make the task of loosening and removing the cap too difficult to be performed by hand.

According, there exists a need to develop a container having features specifically configured to enable a user to open the lid or cap of such container by hand in a manner that overcomes the impediments noted above existing with known containers and caps.

### SUMMARY

Containers as disclosed herein generally comprise a container body and a cap. The container body is capable of accommodating a desired volume of material, e.g., fluid, gas, powder or the like, and has an opening through which the material can be removed. A cap is removably attached to the container body open for purposes of sealing the material inside from inadvertently escaping. In an example embodiment, the container cap is configured to be threadably engaged with the container body so that the cap can be loosened and/or removed by a user twisting the cap relative to the body to threadably decouple the cap from the bod. In an example, the cap comprises a surface feature that is configured to be engaged by a member for providing additional leverage to the user to the cap for removal and/or loosening.

In an example, the surface feature can be any feature that is configured to cooperate and provide an interlocking connection with the member. In an example, the cap surface feature may be provided in the form of an opening positioned diametrically relative to the cap and that may extend completely or partially through the cap to accommodate placement of the member therein. Alternatively, the surface feature may be provided in the form of a projecting element or recessed element on the cap and the member may comprise a surface feature that complements and interlocks with the cap surface feature to provide the addition leverage useful for cap loosening and/or removal. In an example, the member may be another container and the surface feature that cooperates with the surface feature of the cap may be located on the cap or container body of the other container.

In an example embodiment, where the cap surface feature comprises an opening, the other container includes a cap that has a section, e.g., a reduced diameter section, that is sized to fit within the opening to provide the desired increased leverage. In another example embodiment, where the cap surface feature is a projecting element or a recess, the other container may comprise a cap or a container body having a surface that includes a complementary surface feature configured to cooperate with and interlock with the surface feature of the cap to provide the desired increased loosening and/or removal leverage. If the other container comprises the surface feature on the cap, it may be positioned along a top surface of the cap. If the other container comprises the surface feature on the container body, it may be positioned along a bottom surface of the container body.

In an example embodiment, a system for aiding loosening of a cap threadably attached to a container body of a container from the container body comprises a pair of containers each comprising a container body and a container cap, wherein one of the container caps comprises a surface feature that is configured to register with one of a surface feature of the other container cap a surface feature of the other container body, and wherein upon registration of the surface features additional leverage is provided to a user to facilitate hand removal of a container cap from container body by twisting or turning movement as between the paid of containers.

Depending on how the container cap surface feature and the member or surface feature of another container are configured, the container and member may be oriented perpendicular relative to one another or coaxial relative to one another to provide the desired additional leverage to a user to loosen and/or remove the cap by hand.

A method for loosening or removing a cap from a container as disclosed herein, wherein the container comprises a body and a cap attached thereto and comprising a volume of liquid or gas to be removed therefrom, comprises aligning a surface feature of the container cap with a another member, wherein such other member may be another container. Once the surface feature of the container cap and member are aligned with one another, they are engaged to thereby form an interlocking attachment therebetween. Once such attachment is achieved, the user may loosen and/or remove the cap by rotating one of the member or the container body relative to the other. As noted above, the member may be provided in the form of another container comprising a surface feature positioned on the other container cap or other container body that is configured to register and form an interlocking connection with the cap for providing a relatively easier leveraged loosening and/or removal of the cap by hand.

### BRIEF DESCRIPTION OF THE DRAWINGS

These and other features and advantages of containers as disclosed herein will be appreciated as the same becomes better understood by reference to the following detailed description when considered in connection with the accompanying drawings wherein:

FIG. 1 is a perspective view of an embodiment of containers as disclosed herein comprising caps configured to facilitate cap loosening/removal;

FIG. 2 is a perspective view of another embodiment of containers as disclosed herein comprising caps configured to facilitate cap loosening/removal;

FIG. 3 is a perspective view of another embodiment of containers as disclosed herein comprising caps configured to facilitate cap loosening/removal;

FIG. 4 is a perspective view of another embodiment of containers as disclosed herein comprising complementary features in the cap and container configured to facilitate cap loosening/removal; and

FIG. 5 is a perspective view of the embodiment of container illustrated in FIG. 1 illustrating the use of an object independent of another container to engage the cap to facilitate cap loosening/removal.

### DETAILED DESCRIPTION

Containers as disclosed herein are specially engineered to include surface features present in one or both of the container body and container cap that are complement one another such that engagement of a surface feature of one container with the complementary surface feature of another container operates to enable a user to easily loosen and/or remove the cap of the container by hand, thereby overcoming the impediments noted above as associated with threaded engagements between the cap and container becoming too tight to permit loosening of the cap by hand. In an example, the containers may be constructed having caps configured with surface features complementary to one another so that the surface feature of one cap engages the surface feature of the other cap to facilitate removal of one of the caps. In another embodiment, the containers may be construction having a cap configured having a surface feature that is complementary to a surface figure of another container such that engagement of the cap surface feature of one container with the surface feature of another container enables a user to easily remove the cap by rotation of one of the container relative to the other. Further details and features of containers as disclosed herein are presented below with reference to certain figures.

It is to be understood that while containers as disclosed and illustrated herein are presented in the context of certain container embodiments, containers comprising the features as disclosed herein for purposes of enabling loosening and removal of caps from containers are intended to apply to all containers however shaped or embodied, such as bottles, tubes, jars and the like and containing any type of material such as fluids, powders, gases and the like for any purpose, such that the features disclosed herein are understood to not be limited to any particular container type.

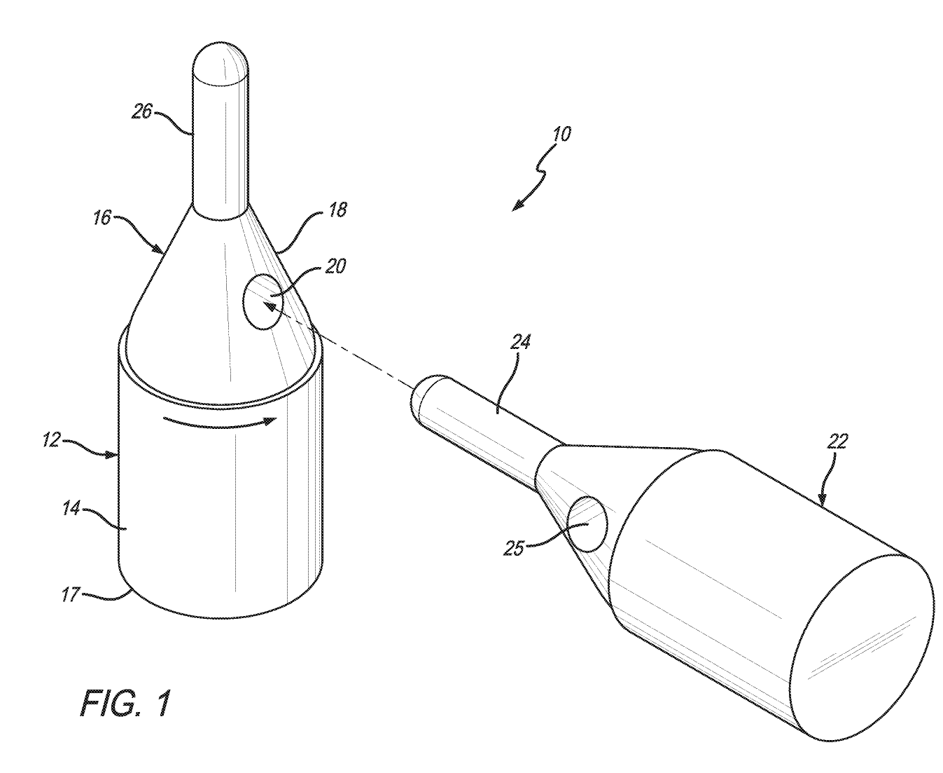

FIG. 1 illustrates an example embodiment of a pair of containers 10 as disclosed herein configured to facilitate loosening and/or removal of a cap by hand. In this embodiment, a first container 12 comprises a body 14 and a cap 16, wherein the body may be made from any suitable material for containing a volume of liquid, such as glass, plastic, metal and the like. The body has a generally cylindrical shape with a closed end forming a bottom 17 and an open end (not shown) opposite the closed end and comprising reduced diameter neck (relative to the body) extending axially outwardly away from the body and having an outside surface that is threaded to facilitate threaded engagement with the cap 16.

The cap 16 may be formed from any suitable material, such as plastic, glass, wood, metal and the like capable of forming a threaded attachment with the container. Thus, the cap includes an axially extending internal cavity that is threaded in a manner that complements the threaded outside surface of the container opening. The cap may have an outer surface 18 that is in the cylindrical in shape as illustrated, or alternatively may be square, rectangular or of any other shape. The cap outside surface 18 may or may not complement that of the container body. I feature of the cap 16 in this embodiment is that it includes a surface feature in the form of an opening 20 passing diametrically through the cap. In such an embodiment, it is desired that the cap be configured having a sufficient radial thickness to permit the placement of the opening therethrough without otherwise weakening the structure of the cap.

In the example illustrated, the cap opening 20 is sized to accommodate placement of an identically configured second container 22 cap surface feature 24 therein. In such example embodiment, the caps of both the first and second container 12 and 22 are configured identically, and each respective cap comprises an opening 20 and 25, and a reduced diameter section 26 and 24 that is configured to fit within the respective openings 25 and 20. In such example, for each cap, the reduced diameter section is positioned adjacent the opening and extends a distance therefrom forming the distal end of the cap. This is but one example embodiment of how caps of containers may be configured identically to include surface features that cooperate/engage with one another to permit a user to combine the containers in a manner where one container cap engages the other container cap for purposes of facilitating loosening and/or removal of the container cap by hand quickly and easily. While the openings 20 and 25 have been shown having a circular configuration, it is to be understood that the opening can have any other type of configuration capable of cooperating with the reduced diameter section.

In an example use, the reduced diameter section of one container cap is placed within the opening of the other container cap to place the relative containers perpendicular to one another. This is beneficial for purpose of creating a horizontal leverage point (via the container positioned in a horizontal position with its reduced diameter section disposed in the opening of the container in a vertical position) useful for more easily loosening and/or removing the cap of the container (in the vertical position). It is to be understood, that the containers do not have to be positioned horizontally or vertically to benefit from the improved leverage gained by a user from the relative perpendicular orientation of the containers once the surface features are engaged.

In an example end use, both containers may be nail polish containers where a user would have a number of such containers that contain a different color or type of nail polish, so it would be easy to have two or more such containers readily available to the user for purposes of combining in the manner noted to facilitate cap removal. In such example use, it is well known that nail polish on the threaded portion of the container or cap may operate to otherwise make removal difficult by hand. It is understood that there may be many more such container cap embodiments that may accomplish the intended function, all of which container cap embodiments are intended to be within the scope of this disclosure.

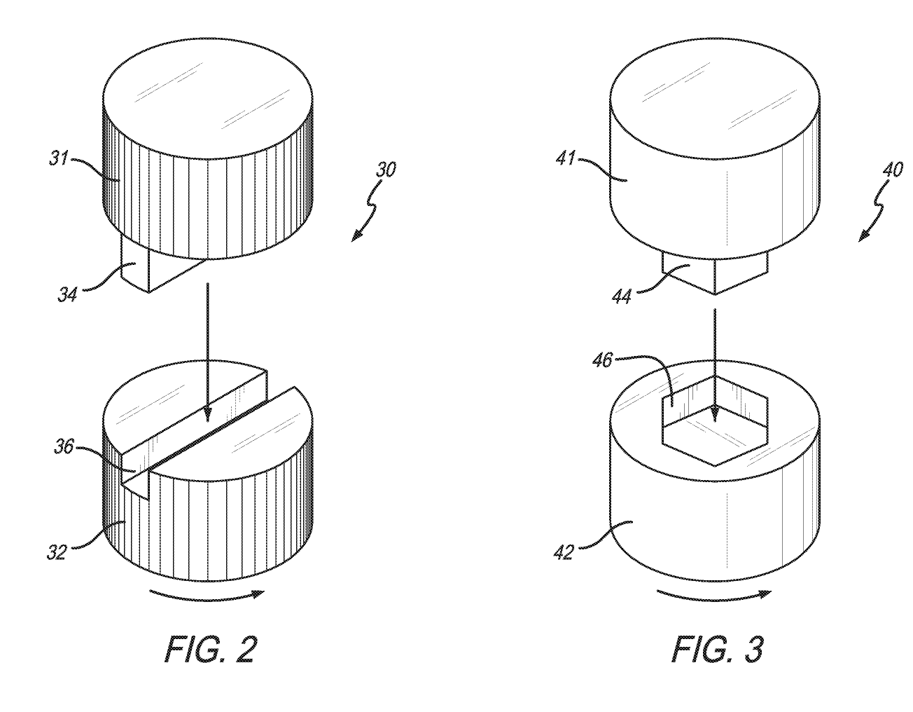

FIG. 2 illustrates FIG. 1 illustrates an example embodiment of a pair of containers 30 comprising container caps 31 and 32 as disclosed herein configured to facilitate loosening and/or removal of a cap by hand. In this embodiment, one or both of the container caps are connected to a respective container. In this embodiment, the container cap 31 comprises a surface feature 34 that is configured to cooperate with surface feature 36 of the container cap 32. The surface feature 34 is configured in the form of a projecting element that is sized and shaped to fit within the surface feature 36 provided in the form of a recess. In this embodiment, the projecting element 34 is provided in the form of a blade extending outwardly from the surface of the cap 31, and the recess 36 is provided in the form of a slot disposed a depth below a top surface of the cap 32 and configured to accommodate the blade therein. Configured in this manner, a user can loosen and/or remove the cap 32 that is connected with a container (not shown) by using the cap 31 (attached or not attached to a respective container) and twisting one cap/container relative to the other. While this is but one example embodiment illustrating caps configured having differently-shaped surface features designed to cooperate with one another to permit interlocking engagement for facilitate loosening and/or removal of one cap relative to the other, it is understood that many other such complementary differently-shaped surface features that function to provide the desired interlocking engagement are possible and that such is thereby understood and intended to be within the scope of the containers as disclosed herein.

FIG. 3 illustrates an example embodiment of a pair of container 40 comprising caps 41 and 42 as disclosed herein configured to facilitate loosening and/or removal of a cap by hand. In this embodiment, one or both of the container caps are connected to a respective container. In this embodiment, the container cap 41 comprises a surface feature 44 that is configured to cooperate with surface feature 46 of the container cap 42. In an example, the surface feature 44 is configured in the form of a projecting element or the like that is sized and shaped to fit within the surface feature 46 provided in the form of a recess. In this embodiment, the projecting element 44 is provided in the form of a hexagonal head extending outwardly from the surface of the cap 41, and the recess 46 is provided in the form of a hexagonal opening disposed a depth below a top surface of the cap 42 and configured to accommodate the hexagonal head therein. Configured in this manner, a user can loosen and/or remove the cap 42 that is connected with a container (not shown) by using the cap 41 (attached or not attached to a respective container) and twisting one cap relative to the other. While this is but one example embodiment illustrating caps configured having differently-shaped surface features designed to cooperate with one another to permit engagement for facilitate loosening and/or removal of one cap relative to the other, it is understood that many other such complementary differently-shaped surface features are possible and that such is understood and intended to be within the scope of the containers as disclosed herein.

Further, while the surface features 44 and 46 have each been described as being part of the cap, in an alternative embodiment one of the surface features can be provided as part of the container body, e.g., disposed at the container bottom or the like, so that the desired cap loosening and/or removal may occur by engaging the bottom of one container body with the cap of another container. In such embodiment, it is useful if the surface feature of the container body, if disposed along the body bottom surface, is one configured in a manner that enables the placement/storage of the container on a planar surface. In the embodiments illustrated in FIGS. 2 and 3 during the process of engaging the surface features the containers are positioned relative to one another in a common axial alignment.

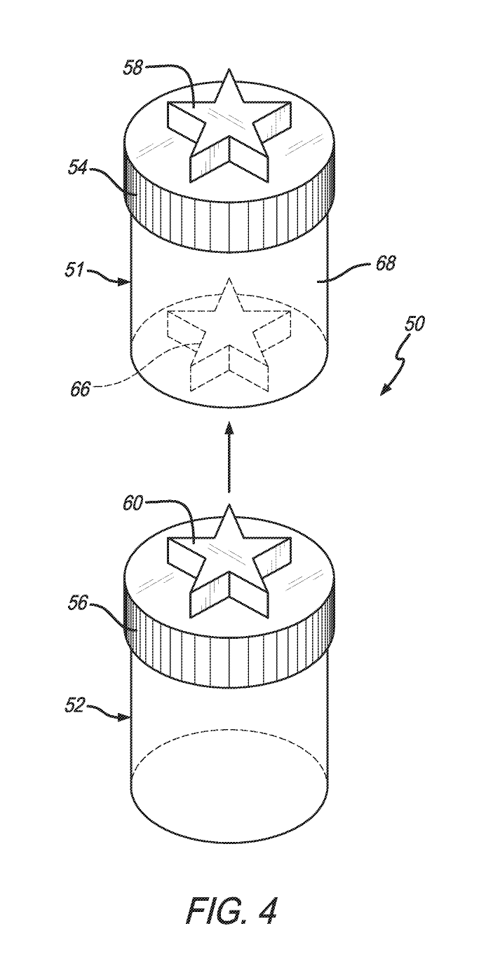

FIG. 4 illustrates an example embodiment of containers 50 comprising of pair of containers 51 and 52 as disclosed herein configured to facilitate loosening and/or removal of a container cap by hand. In this embodiment, one or both of the container caps are connected to a respective container. In this embodiment, each of the containers 51 and 52 may be configured comprising caps 54 and 56 that are each configured having the same type of surface feature 58 and 60. In an example, the surface 58 and 60 features are disposed along a top surface of the caps. In example, the surface feature 60 is configured to project outwardly a distance from the cap 56 top surface and is shaped to cooperate with a surface feature 66 of a body 68 of the container 51. In the illustrated example, the cap surface feature is provided in the form of a star-shaped projection, and the container body surface feature is provided in the form of a complementary star-shaped recess to accommodate the star projection therein. It is to be understood that the surface features of the cap and container body may be other than as illustrated and described for purposes of providing a complementary interlocking engagement and fit therebetween, and that all other such configurations of surface features capable of providing an interlocking engagement for the desired purpose are intended to be within the scope of the containers as described herein.

Configured in this manner, a user can loosen and/or remove the cap 56 that is connected with the container 52 by engaging the surface feature 60 of the cap 56 with the surface feature 66 of the container body 68, and once engaged the user may loosen and/or remove the cap 56 by relative rotation of the containers 51 and 52. As noted above, while this is but one example embodiment illustrating caps configured with surface features designed to cooperate with surface features of container bodies, it is to be understood that any and all configurations of surface features between caps and bodies that provide such cooperative engagement for the purpose of enabling loosening and/or removal of a cap by use of another container are understood to be within the scope of containers as disclosed herein. For example, while the surface feature of the container body has been illustrated as being positioned along a bottom portion of the container, it is to be understood that the surface feature that registers with a surface feature of a cap may be located at a position on the container body other than on the bottom surface, such as along a sidewall surface of the like.

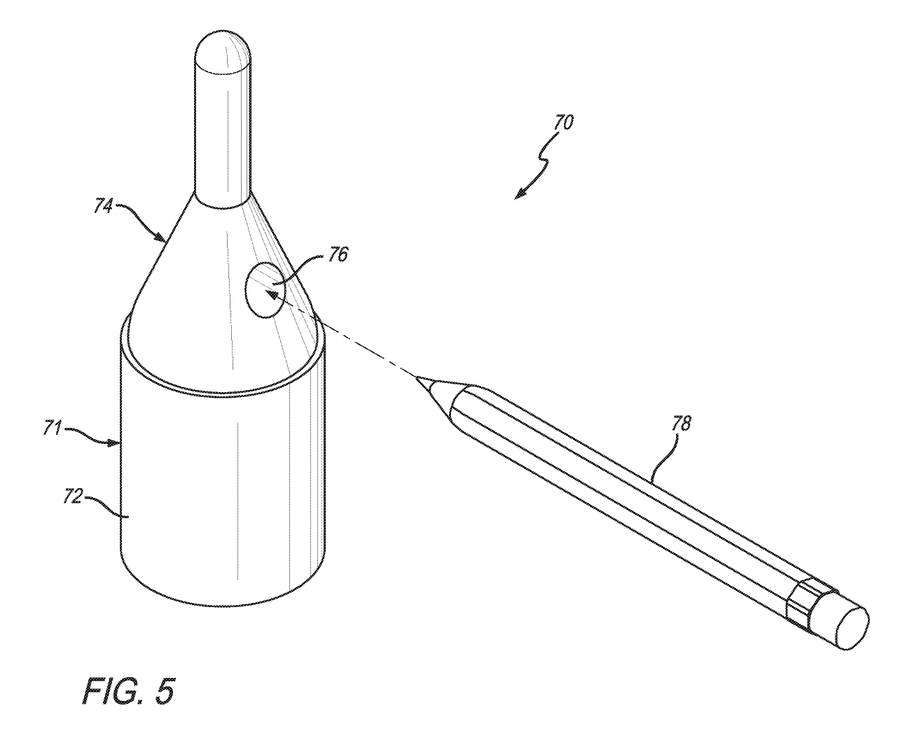

FIG. 5 illustrates and embodiment of system 70 for removing a container cap comprising a container 71 as disclosed herein that is similar to the container illustrated in FIG. 1, wherein the container comprises a container body 72 and a cap 74 attached to an open end of the container body. As illustrated, the cap is configured having a surface feature 76 in the form of an opening extending diametrically partially or completely through a portion of the cap. As mentioned above for the embodiment illustrated in FIG. 1, such opening may operate to accommodate placement of a cap reduced diameter section of another identically-configured container for the purpose of providing additional leverage to thereby facilitate loosening and/or removing the cap 74 from the body, i.e., by rotating one of the cap 74 or body 72 relative to the other of the cap or body. In the embodiment illustrated in FIG. 3, a member 78 (other than a portion of another container) that is capable of fitting into the cap opening 76 is used for the purpose of being placed into the cap opening for providing added leverage to a user for purposes of facilitating loosening and/or removing the cap from the container body by hand. In an example, the member 78 may be in the form of a readily-available object such as a pencil or pen or the like. However, it is to be understood that any other members capable of fitting into the cap opening for the intended purpose of providing additional leverage for purposes of rotatably loosening and/or removing the cap from the container body are intended to the within the scope of this concept and disclosure.

A feature of the containers as disclosed herein is that they are construction in a manner that enables a user to loosen and/or remove a cap from engaging/releasibly interlocking two caps and/or containers together for the purpose of providing added leverage to a user to enable the user to open an otherwise difficult-to-open cap by hand. The surface features provided in the caps and/or containers may be provided by conventional means depending on the type of construction material, e.g., the surface features may be provided by molding, stamping, printing, machining or other methods known in the art.

Containers as disclosed herein may be used for the purpose of easing the leverage removal of a cap from a container body by a user in the following manner. The user engages the member with the surface feature of the cap container so that the member forms an interlocking engagement with the cap. In an example, the member may be another container as described above comprising a complementary surface feature that fits with the cap surface feature, and wherein the complementary surface feature may be part of the other container cap or other container body depending on the particular embodiment. The user may then loosen and remove the cap by grasping the member or other container engaged with the cap and rotating one of the container or member relative to the other, wherein the member or other container provide a desired degree of increased leverage to the user to more easily loosen and/or remove the container cap by hand.

Other modifications and variations of containers as disclosed herein will be apparent to those skilled in the art. It is, therefore, to be understood that within the scope of the appended claims, the containers as disclosed herein may be practiced otherwise than as specifically described. While containers have been described an illustrated having example configurations, it is to be understood that containers as disclosed herein may take on any configuration useful for accommodating a volume of material, such as bottles, tubes, cans and the like. It is also understood that the contents of such containers are not limited for a particular end use and may include any and all types of materials including and not limited to liquids, powders, gases and the like for all types of end uses applications that are not herein limited. Examples of such uses may include and are not limited to cosmetics, medicines, household materials, office supplies, paints, tooth pastes, sealants and the like.

What is claimed is:

1. A container having an opening feature, the container comprising:
a body capable of accommodating a volume of material, the body having a closed end and an open end, wherein the open end is provided for removal of the volume of material therefrom; and
a cap threadably connected with the body open end to seal the volume of material within the container, the cap comprising a surface feature configured for engagement with a member for purposes of providing additional leverage to a user for removing the cap from the container body.

2. The container as recited in claim 1 wherein the cap surface feature is provided in the form of an opening positioned diametrically in the cap and sized to accommodate placement of the member therein.

3. The container as recited in claim 2 wherein the opening extends partially or completely through the cap.

4. The container as recited in claim 1 wherein the member is a portion of another container that has a surface feature configured to cooperate with the cap surface feature.

5. The container as recited in claim 4 wherein container surface feature is provided in the form of an opening, and wherein the container cap further comprises a reduced diameter section extending to a distal end of the container cap.

6. The container as recited in claim 5 wherein the member is the reduced diameter section of another container cap.

7. The container as recited in claim 5 wherein the other container includes a container body that include the surface feature configured to cooperate with the container cap surface feature.

8. The container as recited in claim 7 wherein the container cap surface feature projects outwardly from a cap top surface and the other container body surface feature is recessed to accommodate placement of the container surface feature therein.

9. A system for aiding loosening of a cap threadably attached to a container body of a container from the container body, the system comprising a pair of containers each comprising a container body and a container cap, wherein one of the container caps comprises a surface feature that is configured to register with one of a surface feature of the other container cap a surface feature of the other container body, and wherein upon registration of the surface features additional leverage is provided to a user to facilitate hand removal of a container cap from container body by twisting or turning movement as between the paid of containers.

10. The system as recited in claim 9 wherein both containers have identically configured caps with identically configured surface features.

11. The system as recited in claim 10 wherein the caps of each container are threadably attached to the respective container body.

12. The system as recited in claim 10 wherein the cap surface features comprise an opening that extends diametrically partially or completely through the cap, and a reduced diameter section that extends to a distal end of the cap and is sized to fit within the opening of the other cap.

13. The system as recited in claim 10 wherein when the surface features of the caps are engaged with one another, one container is oriented perpendicular to the other container.

14. The system as recited in claim 10 wherein the container cap surface feature comprises a projection extending outwardly from a top surface of the cap, and the other container cap surface feature comprises a recess configured to accommodate placement of the projection therein.

15. The system as recited in claim 14 wherein when the surface features of the caps are engaged with one another, the containers are oriented with respect to one another having a common axial alignment.

16. The system as recited in claim 9 the container cap surface feature is configured to project outwardly a distance from an outside surface of the cap, and wherein the other container surface feature is disposed in the container body and is configured to accommodate placement of the cap surface feature therein.

17. A method for loosening or removing a cap from a container, the container comprising a body and a cap attached thereto and comprising a volume of liquid or gas to be removed therefrom, wherein the method comprises the steps of:
aligning a surface feature of the container cap with a another member;
engaging the surface feature with the member to thereby form an interlocking attachment therebetween; and
moving one of the member or the container body by hand to loosen the container cap from the body.

18. The method as recited in claim 17 wherein the other member is another container, and wherein the surface feature of the other member is disposed on the other container cap or container body.

19. The method as recited in claim 18 wherein the surface feature of the container cap comprises an opening that extends diametrically partially or completely therethrough, and wherein the other container cap comprises a reduced diameter section that is engaged within the opening, and wherein during the step of moving the containers are oriented perpendicular to one another.

20. The method as recited in claim 18 wherein during the step of moving, the containers are oriented relative to one another along a common axis.
